(19) United States
(12) Patent Application Publication
(10) Pub. No.: US 2019/0309117 A1
(43) Pub. Date: Oct. 10, 2019

(54) Moisture-Curable Compositions Comprising Silane-Grafted Polyolefin Elastomer and Halogen-Free Retardant

(71) Applicants: Dow Global Technologies LLC, Midland, MI (US); Rohm and Haas Company, Collegeville, PA (US)

(72) Inventors: Yichi Zhang, Collegeville, PA (US); Bharat I. Chaudhary, Collegeville, PA (US); Morgan M. Hughes, Angleton, TX (US); Xindi Yu, Collegeville, PA (US)

(21) Appl. No.: 16/308,987

(22) PCT Filed: Jun. 8, 2017
(86) PCT No.: PCT/US2017/036493

§ 371 Date: Dec. 11, 2018

Related U.S. Application Data
(60) Provisional application No. 62/349,828, filed on Jun. 14, 2016.

(51) Int. Cl. C08F 255/02; H01B 3/44; H01B 7/295; C08K 3/12; C08K 3/22; C08K 9/06; C08K 9/04; C08K 5/00

(52) U.S. Cl. CPC C08F 255/02; H01B 3/441; H01B 7/295; C08K 3/12; C08F 2810/20; C08K 9/06; C08K 9/04; C08K 5/005; C08K 2003/2224; C08K 3/22

(57) ABSTRACT

Compositions useful as coatings for wire and cable comprise, in weight percent (wt %) based on the weight of the composition: (A) 10 to 62 wt % of a silane-grafted ethylene polymer (Si-g-PE) having a silane content of 0.5 to 5 wt % based on the weight of the Si-g-PE, wherein the Si-g-PE is made from an ethylene polymer (base resin) having the following properties. (1) Density of 0.875 to 0.910 g/cc; (2) Melt index (MI, 12) of 8 to 50 g/10 min (190° C./2.16 kg); and (B) 38 to 90 wt % of a halogen-free flame retardant (HFFR); (C) 0 to 0.3 wt % of an antioxidant; and (D) 0 to 1 wt % of a silanol condensation catalyst.

### FIELD OF THE INVENTION

This invention relates to moisture-curable compositions. In one aspect, the invention relates to moisture-curable compositions comprising a silane-grafted polyolefin elastomer (Si-g-POE) while in another aspect, the invention relates to such compositions further comprising a halogen-free flame retardant (HFFR). In still another aspect, the invention relates to Si-g-POE/HFFR compositions containing a high loading of HFFR. In yet another aspect, the invention relates to cable insulation made from such compositions.

### BACKGROUND OF THE INVENTION

The art is replete with silane-grafted polyolefin elastomers (Si-g-POE) and processes for their preparation. See for example, U.S. Pat. No. 5,741,858, US 2006/0100385 and U.S. Pat. No. 8,519,054). The art also teaches blends of Si-g-POE and halogen-free flame retardant (HFFR). See for example, U.S. Pat. No. 4,549,041, US 2003/013969 and US 2010/0209705. However, the science of making a wire or cable covering from a blend of a Si-g-POE and an HFFR is not as easy as simply compounding the Si-g-POE with the HFFR. The chemistry between silane and the hydroxyl groups/moisture in HFFR is complicated, and scorch-free, i.e., avoidance of premature crosslinking, extrusion of such compositions is a basic consideration in the manufacture of wire and cable coverings. Other considerations for a useful wire and cable covering include tensile strength, elongation at break, limiting oxygen index (LOI), hot creep and melt viscosity. Identifying Si-g-POE/HFFR compositions that satisfy these concerns is a continuing challenge to the wire and cable industry.

### SUMMARY OF THE INVENTION

In one embodiment the invention is a composition comprising, in weight percent (wt %) based on the weight of the composition:
(A) 10 to 62 wt % of a silane-grafted ethylene polymer (Si-g-PE) having a silane content of 0.5 to 5 wt % based on the weight of the Si-g-PE, wherein the Si-g-PE is made from an ethylene polymer (base resin) having the following properties
   (1) Density of 0.875 to 0.910 g/cc;
   (2) Melt index (MI, I₂) of 8 to 50 g/10 min (190° C./2.16 kg); and
(B) 38 to 90 wt % of a halogen-free flame retardant (HFFR);
(C) 0 to 0.3 wt % of an antioxidant; and
(D) 0 to 1 wt % of a silanol condensation catalyst.

The compositions of this invention exhibit at least one, or at least two, or at least three, or at least four, or all five of the following properties:
(1) Initial elastic torque value measured by moving die rheometer (MDR Low) of less than (<) 0.6 lb*in (0.068 Nm) in the case of the silane crosslinkable composition at 182° C., the measurement done within 5 minutes of making the composition using a Brabender mixing bowl of 350 ml volume and in which process the HFFR was added to the molten polymer at a set a temperature of 150° C. or less, such that the final melt temperature did not exceed 170° C.
(2) Elongation at break of greater than or equal to (≥) 100% measured according to ASTM D-638;
(3) Tensile strength (peak stress) of greater than or equal to (≥) 1,000 psi (0.049 MPa) measured according to ASTM D-638;
(4) Limiting oxygen index (LOI) of greater than or equal to (≥) 21% measured according to ASTM D2863;and
(5) After crosslinking (moisture cure as described below), a hot creep (measured at 150° C., 0.2 MPa) of less than or equal to (≤) 175% measured according to ICEA T-28-562.

The peak stress (tensile strength) and elongation at break (tensile elongation) are measured on 50 mil (1.27 mm) thick specimens. LOI properties are measured on a 125 mil (3.18 mm) thick specimen with width of 0.26 inch (6.5 mm) and a length of 4 inch (102 mm). The measurements can be taken either before or after moisture cure of the composition. Moisture cure (crosslinking) is performed by placing the specimen in a water bath maintained at 90° C. for 8 hours.

Surprisingly, in spite of the fact that the compositions of this invention are made using polyethylene of relatively high melt index (i.e., low molecular weight), the degree of crosslinking after 8 hours or more of moisture cure in a 90° C. water bath (optionally by incorporating a silanol condensation catalyst in the formulation) is high as demonstrated by hot creep values of well below 175%.

In one embodiment the invention is the composition before crosslinking. In one embodiment the invention is the composition after crosslinking. In one embodiment the crosslinking of the composition is promoted with a silanol condensation catalyst or agent. In one embodiment the invention is a wire or cable coated with the inventive composition. In one embodiment the composition forms an insulation sheath or protective jacket on or for the wire or cable.

### BRIEF DESCRIPTION OF THE FIGURES

FIG. 1 is a plot of the tensile strength of an HFFR composition as a function of the density of a base resin for comparative and inventive examples of the invention.

FIG. 2 is a plot of the elongation at break of an HFFR composition as a function of the density of a base resin for comparative and inventive examples of the invention.

FIG. 3 is a plot of elongation at break of an HFFR composition as a function of filler weight percentage for comparative and inventive examples of the invention.

FIG. 4 is a plot of tensile strength of an HFFR composition as a function of filler weight percentage for comparative and inventive examples of the invention.

FIG. 5 is a plot of LOI of an HFFR composition as a function of filler weight percentage for comparative and inventive examples of the invention.

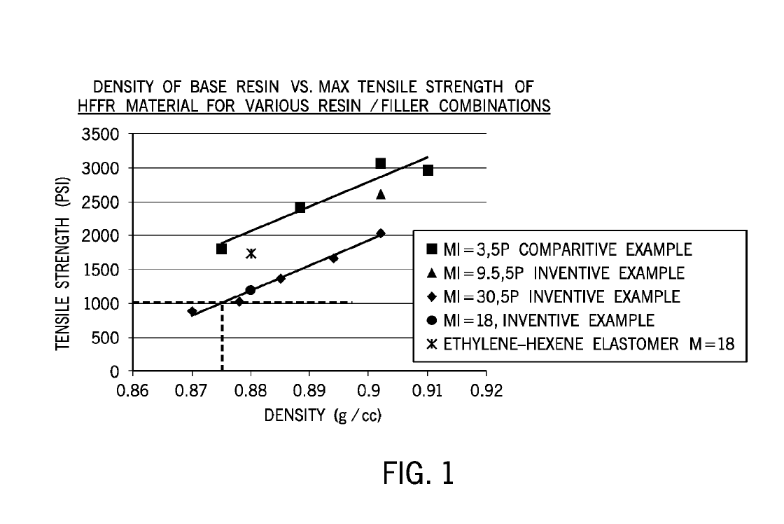

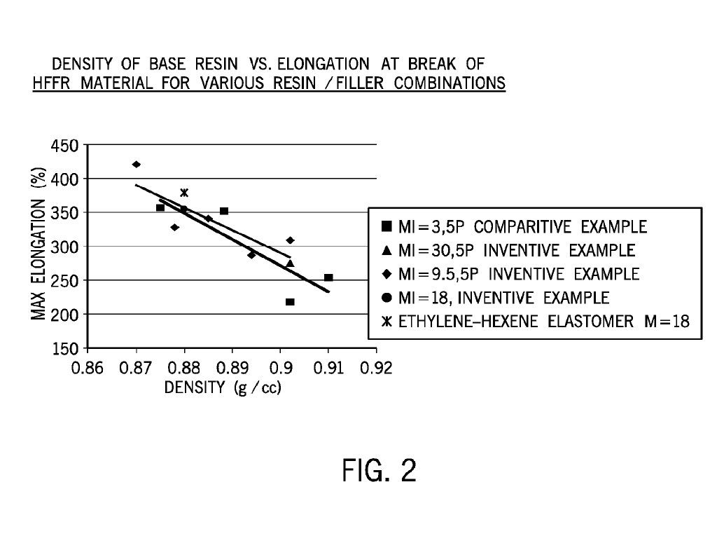

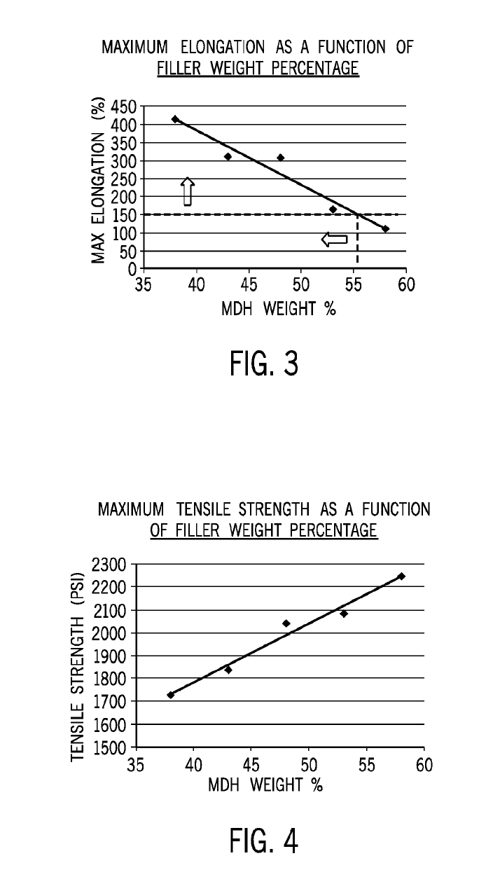

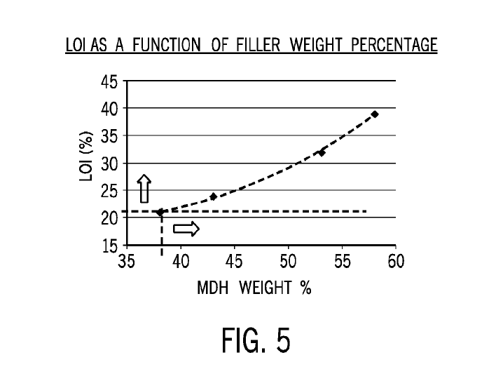

### DESCRIPTION OF THE PREFERRED EMBODIMENTS

### Definitions

Unless stated to the contrary, implicit from the context, or customary in the art, all parts and percents are based on weight and all test methods are current as of the filing date of this disclosure. For purposes of United States patent practice, the contents of any referenced patent, patent application or publication are incorporated by reference in their entirety (or its equivalent US version is so incorporated by reference), especially with respect to the disclosure of definitions (to the extent not inconsistent with any definitions specifically provided in this disclosure) and general knowledge in the art.

Numerical ranges include all values from and including the lower and the upper values, in increments of one unit, provided that there is a separation of at least two units between any lower value and any higher value. As an example, if a compositional, physical or other property, such as, for example, molecular weight, viscosity, melt index, etc., is from 100 to 1,000, it is intended that all individual values, such as 100, 101, 102, etc., and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, density, melt index and various physical properties of the inventive compositions.

“Wire” and like terms refer to a single strand of conductive metal, e.g., copper or aluminum, or a single strand of optical fiber.

“Cable” and like terms means at least one conductor, e.g., wire, optical fiber, etc., within a protective jacket or sheath. Typically, a cable is two or more wires or optical fibers bound together, typically in a common protective jacket or sheath. The individual wires or fibers inside the jacket may be bare, covered or insulated. Typical cable designs are described in SAE J-1128.

“Polymer” means a polymeric compound prepared by polymerizing monomers, whether of the same or a different type. The generic term polymer thus embraces the term homopolymer, usually employed to refer to polymers prepared from only one type of monomer, and the term interpolymer or copolymer as defined below.

“Ethylene polymer” means a polymer containing units derived from ethylene. Ethylene polymers typically comprises at least 50 mole percent (mol%) units derived from ethylene. Polyethylene is an ethylene polymer.

“Interpolymer” and “copolymer” mean a polymer prepared by the polymerization of at least two different types of monomers. These generic terms include both classical copolymers, i.e., polymers prepared from two different types of monomers, and polymers prepared from more than two different types of monomers, e.g., terpolymers, tetrapolymers, etc.

“Polyolefin” and like terms mean a polymer derived from simple olefin monomers, e.g., ethylene, propylene, 1-butene, 1-hexene, 1-octene and the like. The olefin monomers can be substituted or unsubstituted and if substituted, the substituents can vary widely. For purposes of this invention, substituted olefin monomers include vinyltrimethoxysilane (VTMS) and vinyltriethoxysilane (VTES). Polyolefins include, but are not limited to, polyethylene.

“Blend,” “polymer blend” and like terms mean a blend of two or more polymers. Such a blend may or may not be miscible. Such a blend may or may not be phase separated. Such a blend may or may not contain one or more domain configurations, as determined from transmission electron spectroscopy, light scattering, x-ray scattering, and any other method known in the art.

“Silane-grafted ethylene polymer”, “silane-grafted polyethylene”, “Si-g-PE” and like terms means a silane-containing ethylene polymer prepared by a process of grafting a silane functionality onto the polymer backbone of the ethylene polymer as described, for example, in U.S. Pat. No. 3,646,155 or 6,048,935. Si-g-PE also includes a copolymer prepared from the reactor copolymerization of ethylene and a vinyl silane substituted alpha-olefin, e.g., VTMS.

“Composition” and like terms means a mixture or blend of two or more components. In the context of a mix or blend of materials from which a Si-g-PE is prepared, the composition includes at least one ethylene polymer, a vinyl silane, and a free radical initiator. In the context of a mix or blend of materials from which a cable sheath or other article of manufacture is fabricated, the composition includes all the components of the mix, e.g., the Si-g-PE, the HFFR, the antioxidant, and any other additives such as cure catalysts, process aids, etc.

“Catalytic amount” means an amount necessary to promote the reaction of two components at a detectable level, preferably at a commercially acceptable level.

“Crosslinked” and similar terms mean that the polymer, before or after it is shaped into an article, has xylene or decalin extractables of less than or equal to 90 weight percent (i.e., greater than or equal to 10 weight percent gel content).

“Cured” and like terms means that the polymer, before or after it is shaped into an article, was subjected or exposed to a treatment which induced crosslinking.

“Crosslinkable” and like terms means that the polymer, before or after shaped into an article, is not cured or crosslinked and has not been subjected or exposed to treatment that has induced substantial crosslinking although the polymer comprises additive(s) or functionality which will effectuate substantial crosslinking upon subjection or exposure to such treatment (e.g., exposure to water).

“Halogen-free” and like terms indicate that the flame retardant is without or substantially without halogen content, i.e., contain less than 10,000 mg/kg of halogen as measured by ion chromatography (IC) or a similar analytical method. Halogen content of less than this amount is considered inconsequential to the efficacy of the flame retardant as, for example, in a wire or cable covering.

“Moisture curable” and like terms mean that the composition of this invention will cure, i.e., crosslink, upon exposure to water. The speed and degree of cure or crosslinking is a function of, among other things, the amount of silane functionality in the composition, the nature of the exposure to water (e.g., immersion in a water bath, relative humidity of air, etc.), the duration of the exposure, temperature, and the like. Moisture cure can be with or without the assistance of a cure catalyst (silanol condensation catalyst), promoter, etc.

### Ethylene Polymer

The ethylene polymer, or polyethylene, used in the practice of this invention has a density of 0.875 to 0.910 g/cc, or of 0.878 to 0.910 g/cc, or of 0.883 to 0.910 g/cc as measured by ASTM D-792. The ethylene polymer, or polyethylene, used in the practice of this invention has a melt index (MI, I₂) of 8 to 50 g/10 min, or of 10 to 40 g/10 min, or of 15 to 35 g/10 min as measured by ASTM D-1238 (190° C./2.16 kg).

The ethylene polymer, or polyethylene, used in the practice of this invention is preferably a homogeneous polymer. Homogeneous ethylene polymers usually have a polydispersity index (Mw/Mn or MWD) in the range of 1.5 to 3.5 and an essentially uniform comonomer distribution, and are characterized by a single and relatively low melting point as measured by a differential scanning calorimetry (DSC). Substantially linear ethylene copolymers (SLEP) are homogeneous ethylene polymers, and these polymers are especially preferred.

As here used, “substantially linear” means that the bulk polymer is substituted, on average, with about 0.01 long-chain branches/1000 total carbons (including both backbone and branch carbons) to about 3 long-chain branches/1000 total carbons, preferably from about 0.01 long-chain branches/1000 total carbons to about 1 long-chain branch/1000 total carbons, more preferably from about 0.05 long-chain branches/1000 total carbons to about 1 long-chain branch/1000 total carbons, and especially from about 0.3 long chain branches/1000 total carbons to about 1 long chain branches/1000 total carbons.

“Long-chain branches” or “long-chain branching” (LCB) means a chain length of at least one (1) carbon less than the number of carbons in the comonomer, as opposed to “short chain branches” or “short chain branching” (SCB) which means a chain length two (2) less than the number of carbons in the comonomer. For example, an ethylene/1-octene substantially linear polymer has backbones with long chain branches of at least seven (7) carbons in length, but it also has short chain branches of only six (6) carbons in length, whereas an ethylene/1-hexene substantially linear polymer has long chain branches of at least five (5) carbons in length but short chain branches of only four (4) carbons in length. LCB can be distinguished from SCB by using ¹³C nuclear magnetic resonance (NMR) spectroscopy and to a limited extent, e.g. for ethylene homopolymers, it can be quantified using the method of Randall (Rev. Macromol. Chem. Phys., C29 (2&3). p.285-29′7). However as a practical matter, current ¹³C NMR spectroscopy cannot determine the length of a long-chain branch in excess of about six (6) carbon atoms and as such, this analytical technique cannot distinguish between a seven (7) and a seventy (70) carbon branch. The LCB can be about as long as about the same length as the length of the polymer backbone.

U.S. Pat. No. 4,500,648 teaches that LCB frequency can be represented by the equation LCB=b/M_{w} in which b is the weight average number of LCB per molecule and M_{w} is the weight average molecular weight. The molecular weight averages and the LCB characteristics are determined by gel permeation chromatography (GPC) and intrinsic viscosity methods.

One measure of the SCB of an ethylene copolymer is its short chain branch distribution index (SCBDI), also known as composition distribution branch index (CDBI), which is defined as the weight percent of the polymer molecules having a comonomer content within 50 percent of the median total molar comonomer content. The SCBDI or CDBI of a polymer is readily calculated from data obtained from techniques know in the art, such as temperature rising elution fractionation (TREF) as described, for example. in Wild et al. Journal of Polymer Science, Poly. Phys. Ed., Vol. 20, p.441 (1982). or as described in U.S. Pat. No. 4,798,081. The SCBDI or CDBI for the substantially linear ethylene polymers useful in the present invention is typically greater than about 30 percent, preferably greater than about 50 percent, more preferably greater than about 80 percent, and most preferably greater than about 90 percent.

“Polymer backbone” or just “backbone” means a discrete molecule, and “bulk polymer” or just “polymer” means the product that results from a polymerization process and for substantially linear polymers, that product may include both polymer backbones having LCB and polymer backbones without LCB. Thus a “bulk polymer” includes all backbones formed during polymerization. For substantially linear polymers, not all backbones have LCB but a sufficient number do such that the average LCB content of the bulk polymer positively affects the melt rheology (i.e. the melt fracture properties).

SLEP and their method of preparation are more fully described in U.S. Pat. Nos. 5,741,858 and 5,986,028.

Mw is defined as weight average molecular weight, and Mn is defined as number average molecular weight. The polydispersity index is measured according to the following technique: The polymers are analyzed by gel permeation chromatography (GPC) on a Waters 150° C. high temperature chromatographic unit equipped with three linear mixed bed columns (Polymer Laboratories (10 micron particle size)), operating at a system temperature of 140° C. The solvent is 1,2,4-trichlorobenzene from which about 0.5% by weight solutions of the samples are prepared for injection. The flow rate is 1.0 milliliter/minute (mm/min) and the injection size is 100 microliters (:1). The molecular weight determination is deduced by using narrow molecular weight distribution polystyrene standards (from Polymer Laboratories) in conjunction with their elution volumes. The equivalent polyethylene molecular weights are determined by using appropriate Mark-Houwink coefficients for polyethylene and polystyrene (as described by Williams and Ward in Journal of Polymer Science, Polymer Letters, Vol. 6, (621) 1968, incorporated herein by reference) to derive the equation:

Mpolyethylene=(a)(Mpolystyrene)^{b}

In this equation, a=0.4316 and b=1.0. Weight average molecular weight, Mw, is calculated in the usual manner according to the formula:

Mw=E(wᵢ)(Mᵢ)

in which wᵢ and Mᵢ are the weight fraction and molecular weight respectively of the i^{th} fraction eluting from the GPC column. Generally the Mw of the ethylene polymer ranges from 42,000 to 64,000, preferably 44,000, to 61,000, and more preferably 46,000 to 55,000.

Typical catalyst systems for preparing homogeneous ethylene polymers include metallocene and constrained geometry catalyst (CGC) systems. CGC systems are used to prepare SLEP.

The ethylene polymers used in the practice of this invention are typically a copolymer of ethylene and one or more alpha-olefins (α-olefins) having 3 to 12 carbon atoms and preferably 3 to 8 carbon atoms. Preferably the α-olefin is one or more, more preferably one, of 1-butene, 1-hexene and 1-octene. The ethylene polymers used in the practice of this invention can comprise units derived from three or more different monomers. For example, a third comonomer can be another α-olefin or a diene such as ethylidene norbornene, butadiene, 1,4-hexadiene or a dicyclopentadiene.

More specific examples of the ethylene polymers useful in this invention include homogeneously branched, linear ethylene/alpha-olefin copolymers (e.g. TAFMER™. by Mitsui Petrochemicals Company Limited and EXACT™ by Exxon Chemical Company); and homogeneously branched, substantially linear ethylene/.alpha.-olefin polymers (e.g. AFFINITY™ plastomers and ENGAGE™ elastomers available from The Dow Chemical Company.

### Vinyl Silane

Any vinyl silane or a mixture of such vinyl silanes that will effectively graft to the ethylene polymer can be used in the practice of this invention. Suitable silanes include those of the general formula:

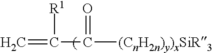

in which R′ is a hydrogen atom or methyl group; x and y are 0 or 1 with the proviso that when x is 1, y is 1; n is an integer from 1 to 12 inclusive, preferably 1 to 4; and each R″ independently is a hydrolysable organic group such as an alkoxy group having from 1 to 12 carbon atoms—(e.g. methoxy, ethoxy, butoxy), aryloxy group (e.g. phenoxy), aralkoxy group (e.g. benzyloxy), aliphatic acyloxy group having from 1 to 12 carbon atoms (e.g. formyloxy, acetyloxy, propanoyloxy), amino or substituted amino groups (alkylamine, arylamino), or a lower alkyl group having 1 to 6 carbon atoms inclusive, with the proviso that not more than two of the three R″ groups is an alkyl (e.g., vinyl dimethyl methoxy silane). Silanes useful in curing silicones which have ketoamino hydrolysable groups, such as vinyl tris(methylethylketoamino) silane, are also suitable. Useful silanes include unsaturated silanes that comprise an ethylenically unsaturated hydrocarboxyl group, such as a vinyl, ally, isopropyl, butyl, cyclohexenyl or gamma-(meth)acryloxy allyl group, and a hydrolysable group, such as, for example, a hydrocarbyloxy, hydrocarbonyloxy, or hydrocarbylamino group. Examples of hydrolysable groups include methoxy, ethoxy, formyloxy, acetoxy, proprionyloxy, and alkyl or arylamino group. Preferred silanes are the unsaturated alkoxy silanes which can be grafted onto the polymers. These silanes and their method of preparation are more fully described in U.S. Pat. No. 5,266,627. Vinyltrimethoxysilane (VTMS), vinyltriethoxysilane (VTES), gamma-(meth)acryloxy propyl trimethoxy silane and mixtures of these silanes are the preferred silanes for use in establishing crosslinks.

The amount of vinyl silane used in the practice of this invention can vary widely depending upon the nature of the polymer to be grafted, the silane, the processing conditions, the grafting efficiency, the ultimate application and similar factors, but typically at least 0.5, preferably at least 1, more preferably at least 2, wt % silane, is used. Considerations of convenience and economy are usually the two principal limitations on the maximum amount of vinyl silane used in the practice of this invention, and typically the maximum amount of vinyl silane does not exceed 5, preferably it does not exceed 4, more preferably it does not exceed 3, wt %. Weight percent silane is the amount of vinyl silane by weight contained in the composition comprising (i) the polyolefin plastomer and/or elastomer, (ii) ethylene copolymer, (iii) non-halogenated flame retardant, and (iv) vinyl silane. The silane content of the silane-grafted polymers is typically between 1 and 3 wt %.

### Free Radical Initiator

The vinyl silane is grafted to the ethylene copolymer by any conventional method, typically in the presence of a free radical initiator, e.g., a peroxide or azo compound, or by ionizing radiation, etc. Organic initiators are preferred, such as any one of the peroxide initiators, for example, dicumyl peroxide, di-tert-butyl peroxide, t-butyl perbenzoate, benzoyl peroxide, cumene hydroperoxide, t-butyl peroctoate, methyl ethyl ketone peroxide, 2,5-dimethyl-2,5-di(t-butyl peroxy)hexane, lauryl peroxide, and t-butyl peracetate. A suitable azo compound is azobisisobutyronitrile.

The amount of initiator can vary, but it is typically present in an amount of at least 0.04, preferably at least 0.06, wt %. Typically the initiator does not exceed 0.15, preferably it does not exceed about 0.10 wt %. The ratio of silane to initiator can also vary widely, but a typical silane:initiator ratio is 20:1 to 70:1, preferably 30:1 to 50:1.

### Silane Grafting of the Ethylene Polymer

Typically the ethylene polymer is grafted with the vinyl silane prior to mixing the silane grafted ethylene polymer (Si-g-PE) with the HFFR. The ethylene polymer, vinyl silane and free radical initiator are mixed using known equipment and techniques, and subjected to a grafting temperature of at least 120° C., preferably of at least 150° C., up to a temperature of 270° C., preferably up to a temperature of 250° C. Typically the mixing equipment is either a BANBURY or similar mixer, or a single or twin-screw extruder.

The silane-grafted ethylene polymers of this invention have the same density ranges as those of the pre-grafted ethylene polymers described above, and melt indices (MI, I₂) of 2 to 50 g/10 min, or of 2.5 to 40 g/10 min, or of 4 to 35 g/10 min as measured by ASTM D-1238 (190° C./2.16 kg).

The amount of Si-g-PE in the composition of this invention is typically 10-62, or 20-60, or 30-58, wt % based on the weight of the composition.

### Halogen-Free Flame Retardant (HFFR)

The halogen-free flame retardant of the disclosed composition can inhibit, suppress, or delay the production of flames. Examples of the halogen-free flame retardants suitable for use in compositions according to this disclosure include, but are not limited to, metal hydroxides, red phosphorous, silica, alumina, titanium oxide, carbon nanotubes, talc, clay, organo-modified clay, calcium carbonate, zinc borate, antimony trioxide, wollastonite, mica, ammonium octamolybdate, frits, hollow glass microspheres, intumescent compounds, expanded graphite, and combinations thereof. In an embodiment, the halogen-free flame retardant can be selected from the group consisting of aluminum hydroxide, magnesium hydroxide, calcium carbonate, and combinations thereof.

The halogen-free flame retardant can optionally be surface treated (coated) with a saturated or unsaturated carboxylic acid having 8 to 24 carbon atoms, or 12 to 18 carbon atoms, or a metal salt of the acid. Exemplary surface treatments are described in U.S. Pat. Nos. 4,255,303, 5,034,442, 7,514,489, US 2008/0251273, and WO 2013/116283. Alternatively, the acid or salt can be merely added to the composition in like amounts rather than using the surface treatment procedure. Other surface treatments known in the art may also be used including silanes, titanates, phosphates and zirconates.

Commercially available examples of halogen-free flame retardants suitable for use in compositions according to this disclosure include, but are not limited to APYRAL™ 40CD available from Nabaltec AG, MAGNIFIN™ H5 available from Magnifin Magnesiaprodukte GmbH & Co KG, and combinations thereof.

The amount of HFFR in the composition of this invention is typically 38-90, or 40-80, or 42-70, wt % based on the weight of the composition.

### Antioxidant

The compositions of this invention optionally comprise at least one antioxidant. “Antioxidant” refers to types or classes of chemical compounds that are capable of being used to minimize the oxidation that can occur during the processing of polymers. The term also includes chemical derivatives of the antioxidants, including hydrocarbyl. The term further includes chemical compounds that, when properly combined with the coupling agent, interact with it to form a complex which exhibits a modified Raman spectra compared to the coupling agent alone.

Examples of antioxidants include, but are not limited to, hindered phenols such as tetrakis[methylene(3,5-di-tert-butyl-4-hydroxyhydro-cinnamate)]methane; bis[(beta-(3,5-ditert-butyl-4-hydroxybenzyl)-methyl-carboxyethyl)]sulphide, 4,4′-thiobis(2-methyl-6-tert-butyl-phenol), 4,4′-thiobis(2-tert-butyl-5-methylphenol), 2,2′-thiobis(4-methyl-6-tert-butylphenol), and thiodiethylene bis(3,5-di-tert-butyl-4-hydroxy)hydrocinnamate; phosphites and phosphonites such as tris(2,4-di-tert-butylphenyl)phosphite and di-tert-butylphenyl-phosphonite; thio compounds such as dilaurylthiodipropionate, dimyristylthiodipropionate, and di stearylthiodipropionate; various siloxanes; polymerized 2,2,4-trimethyl-1,2-dihydroquinoline, n,n′-bis(1,4-dimethyl-pentyl-p-phenylenediamine), alkylated diphenylamines, 4,4′-bi s(alpha, alpha-dimethyl-benzyl)diphenylamine, diphenyl-p-phenylenediamine, mixed di-aryl-p-phenylenediamines, and other hindered amine antidegradants or stabilizers.

The antioxidant, when present, comprises greater than zero, typically at least 0.01, more typically at least 0.02 and even more typically at least 0.03 wt % of the composition. Economics and convenience are the principal limitations on the maximum amount of antioxidant used in the compositions of this invention, and typically the maximum amount does not exceed 0.5, more typically does not exceed 0.3 and even more typically does not exceed 0.1, wt % of the composition.

### Silanol Condensation Catalyst

The compositions of this invention optionally comprise at least one silanol condensation catalyst. Curing or crosslinking of the silane-grafted polymers of this invention is optionally accelerated with a silanol condensation catalyst, and any catalyst that will provide this function can be used in this invention. These catalysts generally include organic bases, carboxylic acids and organometallic compounds including organic titanates and complexes or carboxylates of lead, cobalt, iron, nickel, zinc and tin. Illustrative catalysts include dibutyl tin dilaurate, dioctyl tin maleate, dibutyl tin diacetate, dibutyl tin dioctoate, stannous acetate, stannous octoate, lead naphthenate, zinc caprylate and cobalt naphthenate. Tin carboxylates such as dibutyl tin dilaurate, dimethyl hydroxy tin oleate, dioctyl tin maleate, di-n-butyl tin maleate and titanium compounds such as titanium 2-ethylhexoxide are particularly effective for this invention.

The amount of cure catalyst, or mixture of cure catalysts, if used is a catalytic amount, typically an amount greater than zero, preferably between 0.01 to 1.0, more preferably between 0.01 and 0.5% and more preferably between 0.01 and 0.3, wt %.

### Composition and Wire/Cable Covering

After the ethylene polymer is silane grafted, the silane grafted ethylene polymer, the HFFR and antioxidant are mixed, with or without other additives, e.g., curing catalyst, processing aids, etc., and extruded onto a wire or cable. The catalyst and/or other additives are typically added to the Si-g-PE, HFFR and antioxidant blend in the form of a masterbatch and blended to form a substantially homogeneous mixture which, in turn, is extruded onto the wire or cable. The mixing usually occurs in an extruder using equipment, conditions and protocols well known in the art. After extrusion onto the wire or cable, the coated wire or cable is exposed to moisture using either a sauna or water-bath usually operated at 90 C.

The invention is described more fully through the following examples.

Specific Embodiments
The following are the materials used in these examples:
(1) AFFINITY PL 1845G is an ethylene octene plastomer with a density of 0.91 g/cm³ and a melt index of 3.5 g/10 min available from The Dow Chemical Company.
(2) ENGAGE 8452 is an ethylene-octene elastomer with a density of 0.875 g/cm³ and a melt index of 3 g/10 min available from The Dow Chemical Company.
(3) ENGAGE 8450 is an ethylene-octene elastomer with a density of 0.902 g/cm³ and a melt index of 3 g/10 min available from The Dow Chemical Company.
(4) ENGAGE 8407 is an ethylene-octene elastomer with a density of 0.87 g/cm³ and a melt index of 30 g/10 min available from The Dow Chemical Company.
(5) ENGAGE 8401 is an ethylene-octene elastomer with a density of 0.885 g/cm³ and a melt index of 30 g/10 min available from The Dow Chemical Company.
(6) ENGAGE 8402 is an ethylene-octene elastomer with a density of 0.902 g/cm³ and a melt index of 30 g/10 min available from The Dow Chemical Company.
(7) POE-1 is an ethylene-octene elastomer with a density of 0.88 g/cm³ and a melt index of 18 g/10 min available from The Dow Chemical Company.
(8) POE-2 is an ethylene-hexene elastomer with a density of 0.88 g/cm³ and a melt index of 18 g/10 min available from The Dow Chemical Company.
(9) MARTINAL OL-104/S is a surface coated aluminum trihydrate manufactured by Albemarle with an average particle size of 1.2-2.3 microns and a surface area of 3-5 m²/g. The surface coating is silane.
(10) Vinyltrimethoxysilane (VTMS) 98% 235768 was obtained from Sigma Aldrich.
(11) TRIGONOX 101 is 2,5-dimethyl-2,5-di-(tert-butylperoxy)hexane available from Akzo Nobel.
(12) DFDA-5481 NT is a silanol condensation catalyst masterbatch developed to be used in conjunction with moisture curable ethylene-silane copolymers, such as SI-LINK™ polyethylene DFDA-5451. It is available from The Dow Chemical Company.
(13) DFDA-5488 NT is a silanol condensation catalyst masterbatch developed to be used in conjunction with moisture curable ethylene-silane copolymers, such as SI-LINK™ polyethylene DFDA-5451. It is available from The Dow Chemical Company.

The following protocol was used to make the samples reported in the Table.
(1) Dow ENGAGE™ or AFFINITY™ polyolefin elastomer (POE) or polyolefin plastomer (POP), or POE-1 or POE-2, is first soaked with VTMS (1.4 wt %) and TRIGONOX 101 (800 ppm). Soaked POE or POP is heated in a BRABENDER mixer to melt temperature of 185˜190° C. for 5 minutes at agitation speed of 100 revolutions per minute (rpm) with roller blades. After this step the silane molecules are considered fully grafted. Infrared (IR) absorption measurement shows that the grafted VTMS is about 1.4% of the total polymer mass.
(2) Metal hydrate flame-retardant fillers such as aluminum trihydrate (ATH), phosphate ester coated MDH (Kisuma 5J), a type of coated magnesium hydroxide from Kyowa Chemical, or acrylic silane coated MDH (Kisuma 5P), another type of coated magnesium hydroxide from Kyowa Chemical, is added to the silane grafted POE or POP. An example of the mixing ratio of MDH:POE or MDH:POP is 48:52. The mixture is compounded at 50 rpm in the BRABENDER at melt temperature between 140 and 180° C. for 5 minutes. After this step the two components are consider fully mixed.
(3) The composite is removed and pressed into a 50 mil plaque (at 180° C. under a pressure of 20 tons (4.3 MPa) for mechanical (tensile) tests. After the plaque is made, the tensile tests are carried out with INSTRON equipment with displacement rate of 20 in/min (8.5 mm/s) after overnight conditioning.
   (A) Tensile strength (peak stress) and elongation at break are measured according to ASTM D-638;
   (B) Limiting oxygen index (LOI) is measured according to ASTM D2863;
(4) Some of the compositions were subsequently mixed with silanol condensation catalyst masterbatches (DFDA-5481 or DFDA-5488) at 50 rpm for 2 minutes in the BRABENDER at 140° C., compression molded (at 180° C. for 5 minutes to form 50 mil plaques) and moisture cured in a 90° C. water bath for varying lengths of time to assess degree of crosslinking.
   (D) The degree of cross-linking is tested by hot creep test ANSI/ICEA T-28-562 where a 50 mil (1.27 mm) thick, 0.125 inch (3.18 mm) wide dogbone sample is subjected to an elongation stress of 0.2 MPa under 150° C. for 15 minutes. The percentage elongation is recorded. The requirement of UL-94 is less than 175%.

### Discussion

The HFFR compositions of comparative examples 1-4 (CE1-CE4), made using ethylene polymer of 3 to 3.5 g/10 min melt indices and density less than or equal to 0.91 g/cc, could not be melt blended at set temperatures below 180° C. because the shear heating resulted in final melt temperatures of around 180° C. Consequently, the “MDR low” values of the resulted melt blended HFFR compositions (at 182° C.) were all greater than 0.61 b*in. Comparative example 5 (CE5) made using ethylene polymer of 30 g/10 min melt index and density of 0.87 g/cc could be melt blended with HFFR at set temperature of 140° C. without the final melt temperature exceeding 170° C. However, the tensile strength of CE5 was unacceptably low. Comparative example 6 (CE6) made using ethylene polymer of 30 g/10 min melt index and density of 0.902 g/cc could also be melt blended with HFFR at set temperature of 140° C. without the final melt temperature exceeding 170° C. However, at the HFFR loading level of 58 wt %, the tensile elongation value was unacceptably low. In contrast, the HFFR compositions of the examples of the current invention (IE1 to IE16), made with ethylene polymers of melt indices ranging from 9.5 dg/min to 30 dg/min as well as densities ranging from 0.878 g/cc to 0.902 g/cc and containing 38 to 58 wt % of metal hydrates achieve all the required performance attributes of “MDR low”, tensile strength, tensile elongation, and LOI. Furthermore, the compositions of the inventive examples could also be sufficiently crosslinked to attain hot creep less than 175 wt %, after melt blending with silanol condensation masterbatches and curing in a water bath.

TABLE
Density, Melt Index of Base Resin vs. the Tensile Elongation Property,
MDR Low Value, and Hot Creep (150° C., 15 mins. 20 N/cm2) of IEs and Ces

| | | | | | | Set | | | | |
|---|---|---|---|---|---|---|---|---|---|---|
| | | | | | | temper- | | | | |
| | | | | | | ature | | | | |
| | | | | | | for | Properties-Without Moisture Cure | | | |
| | | | | | | filler | Composite | Composite | MDR | |
| | | Resin | | | Resin | addition | max | max | low | |
| | | density | Filler | Filler | MI | step | elongation | tensile | (182 C.) | |
| | Resin | (g/cc) | % | type | (dg/min) | (° C.) | (%) | (PSI) | (lb in) | LOI |
| CE1 | Engage 8452 | 0.875 | 48 | 5 P | 3 | 180 | 357 | 1810 | 0.90 | N/A |
| CE2 | Engage | 0.8883 | 48 | 5 P | 3 | 180 | 352 | 2417 | 1.05 | N/A |
| | 8452:8450 = 1:1 | | | | | | | | | |
| CE3 | Engage 8450 | 0.902 | 48 | 5 P | 3 | 180 | 218 | 3074 | 1.66 | N/A |
| CE4 | Affinity PL 1845G | 0.91 | 48 | 5 P | 3.5 | 180 | 254 | 2975 | 0.97 | N/A |
| CE5 | Engage 8407 | 0.87 | 48 | 5 P | 30 | 140 | 421 | 891 | 0.09 | N/A |
| IE1 | ENGAGE 8401/8407 blend | 0.878 | 48 | 5 P | 30 | 140 | 328 | 1032 | 0.08 | N/A |
| IE2 | ENGAGE 8401 | 0.885 | 48 | 5 P | 30 | 140 | 341 | 1372 | 0.10 | N/A |
| IE3 | ENGAGE 8402/8407 blend | 0.894 | 48 | 5 P | 30 | 140 | 287 | 1670 | 0.09 | N/A |
| IE4 | Engage 8402 | 0.902 | 48 | 5 P | 30 | 140 | 309 | 2042 | 0.10 | N/A |
| IE5 | Engage 8450/Engage | 0.902 | 48 | 5 P | 9.5 | 140 | 275 | 2617 | 0.55 | N/A |
| | 8402 = 1:1 | | | | | | | | | |
| IE6 | POE-1 | 0.88 | 48 | 5 P | 18 | 140 | 355 | 1196 | 0.18 | N/A |
| IE7 | POE-2 | 0.88 | 48 | 5 P | 18 | 140 | 379 | 1744 | 0.21 | N/A |
| IE8 | ENGAGE 8402 + ATH | 0.902 | 48 | ATH | 30 | 140 | 350 | 1554 | 0.04 | N/A |
| IE9 | Engage 8402 (38% filler) | 0.902 | 38 | 5 P | 30 | 140 | 416 | 1728 | 0.05 | 21 |
| IE10 | Engage 8402 (43% filler) | 0.902 | 43 | 5 P | 30 | 140 | 312 | 1839 | 0.07 | 24 |
| IE4 | Engage 8402 (48% filler) | 0.902 | 48 | 5 P | 30 | 140 | 309 | 2042 | 0.10 | N/A |
| IE11 | Engage 8402 (53% filler) | 0.902 | 53 | 5 P | 30 | 140 | 166 | 2085 | 0.12 | 32 |
| IE12 | Engage 8402 (58% filler) | 0.902 | 58 | 5 P | 30 | 140 | 112 | 2249 | 0.27 | 39 |
| IE13 | Engage 8402 (48% filler) | 0.902 | 48 | 5 J | 30 | 140 | 203 | 1351 | 0.10 | N/A |
| IE14 | Engage 8402 + 10% | 0.902 | 48 | 5 J | 30 | 140 | 280 | 2209 | 0.32 | N/A |
| | DFDA-5488 | | | | | | | | | |
| IE15 | Engage 8402 + 2% | 0.902 | 48 | 5 P | 30 | 140 | 179 | 2407 | 0.34 | N/A |
| | DFDA-5481 | | | | | | | | | |
| IE16 | Engage 8402 | 0.902 | 48 | 5 P | 30 | 140 | 260 | 2130 | 0.30 | N/A |
| | 5% DFDA-5488 | | | | | | | | | |

| | | | | | | | | Conditions |
|---|---|---|---|---|---|---|---|---|
| | | | | | | | | used for |
| | | | | | | | | moisture |
| | | | | | | | | cure |
| | | | | | | | | at 90° C. |
| | | | | | | | | Wt % of |
| | | | | | | | | Silanol |
| | | | | | Properties-after Moisture Cure | | | Condensation |
| | | | | | Composite | Composite | Degree of | Catalyst |
| | | Resin | | | max | max | Crosslinking- | Masterbatch |
| | | density | Filler | Filler | elongation | tensile | Hot creep | used and |
| | Resin | (g/cc) | % | type | (%) | (PSI) | (%) | Cure Times |
| CE1 | Engage 8452 | 0.875 | 48 | 5 P | N/A | N/A | N/A | N/A |
| CE2 | Engage 8452:8450 = 1:1 | 0.8883 | 48 | 5 P | 254 | 2975 | N/A | N/A |
| CE3 | Engage 8450 | 0.902 | 48 | 5 P | 254 | 2815 | 68/37 | 4.5% DFDA- |
| | | | | | | | | 5488 (8/63 Hr) |
| CE4 | Affinity PL 1845G | 0.91 | 48 | 5 P | N/A | N/A | N/A | N/A |
| CE5 | Engage 8407 | 0.87 | 48 | 5 P | N/A | N/A | N/A | N/A |
| IE1 | ENGAGE 8401/8407 blend | 0.878 | 48 | 5 P | N/A | N/A | N/A | N/A |
| IE2 | ENGAGE 8401 | 0.885 | 48 | 5 P | N/A | N/A | N/A | N/A |
| IE3 | ENGAGE 8402/8407 blend | 0.894 | 48 | 5 P | N/A | N/A | N/A | N/A |
| IE4 | Engage 8402 | 0.902 | 48 | 5 P | 273 | 1995 | N/A | N/A |
| IE5 | Engage 8450/Engage 8402 = 1:1 | 0.902 | 48 | 5 P | 295 | 2340 | 100 | 5% DFDA- |
| | | | | | | | | 5488 (63 Hr) |
| IE6 | POE-1 | 0.88 | 48 | 5 P | N/A | N/A | N/A | N/A |
| IE7 | POE-2 | 0.88 | 48 | 5 P | N/A | N/A | N/A | N/A |
| IE8 | ENGAGE 8402 + ATH | 0.902 | 48 | ATH | N/A | N/A | N/A | N/A |
| IE9 | Engage 8402 (38% filler) | 0.902 | 38 | 5 P | N/A | N/A | N/A | N/A |
| IE10 | Engage 8402 (43% filler) | 0.902 | 43 | 5 P | N/A | N/A | N/A | N/A |
| IE4 | Engage 8402 (48% filler) | 0.902 | 48 | 5 P | N/A | N/A | N/A | N/A |
| IE11 | Engage 8402 (53% filler) | 0.902 | 53 | 5 P | N/A | N/A | N/A | N/A |
| IE12 | Engage 8402 (58% filler) | 0.902 | 58 | 5 P | N/A | N/A | N/A | N/A |
| IE13 | Engage 8402 (48% filler) | 0.902 | 48 | 5 J | 294 | 1569 | N/A | N/A |
| IE14 | Engage 8402 + 10% DFDA-5488 | 0.902 | 48 | 5 J | 243 | 2072 | 158/96 | 10% DFDA- |
| | | | | | | | | 5488 (8/16 Hr) |
| IE15 | Engage 8402 + 2% DFDA-5481 | 0.902 | 48 | 5 P | 147 | 2486 | 19/17 | 2% DFDA- |
| | | | | | | | | 5481 (8/16 Hr) |
| IE16 | Engage 8402 5% DFDA-5488 | 0.902 | 48 | 5 P | 238 | 2106 | 68 | 5% DFDA- |
| | | | | | | | | 5488 (16 Hr) |

What is claimed is:

1. A composition comprising, in weight percent (wt %) based on the weight of the composition:
(A) 10 to 62 wt % of a silane-grafted ethylene polymer (Si-g-PE) having a silane content of 0.5 to 5 wt % based on the weight of the Si-g-PE, wherein the Si-g-PE is made from an ethylene polymer (base resin) having the following properties
(1) Density of 0.875 to 0.910 g/cc;
(2) Melt index (MI, I₂) of 8 to 50 g/10 min (190° C./2.16 kg); and
(B) 38 to 90 wt % of a halogen-free flame retardant (HFFR);
(C) 0 to 0.3 wt % of an antioxidant; and
(D) 0 to 1 wt % of a silanol condensation catalyst.

2. The composition of claim 1 in which the polyethylene of the Si-g-PE is a substantially linear ethylene polymer (SLEP).

3. The composition of claim 2 in which the SLEP is comprised of units derived from ethylene and a C₃-C₁₂ α-olefin.

4. The composition of claim 1 in which the silane graft of the Si-g-PE is a unit derived from a vinyl silane.

5. The composition of claim 4 in which the vinyl silane is of the general formula: 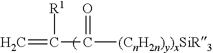
in which R′ is a hydrogen atom or methyl group; x and y are 0 or 1 with the proviso that when x is 1, y is 1; n is an integer from 1 to 12 inclusive, preferably 1 to 4; and each R″ independently is a hydrolysable organic group such as an alkoxy group having from 1 to 12 carbon atoms-(e.g. methoxy, ethoxy, butoxy), aryloxy group (e.g. phenoxy), aralkoxy group (e.g. benzyloxy), aliphatic acyloxy group having from 1 to 12 carbon atoms (e.g. formyloxy, acetyloxy, propanoyloxy), amino or substituted amino groups (alkylamine, arylamino), or a lower alkyl group having 1 to 6 carbon atoms inclusive, with the proviso that not more than two of the three R″ groups is an alkyl (e.g., vinyl dimethyl methoxy silane).

6. The composition of claim 1 in which the density of the Si-g-PE is 0.883 to 0/910 g/cc.

7. The composition of claim 1 in which the melt index of the Si-g-PE is 2 to 50 g/10 min (190° C./2.16 kg).

8. The composition of claim 1 in which the HFFR comprises inorganic filler.

9. The composition of claim 8 in which the HFFR comprises at least one of magnesium hydroxide (MDH), aluminum trihydrate (ATH), calcium carbonate, hydrated calcium silicate, and a hydrated magnesium and/or calcium carbonate.

10. The composition of claim 9 in which the MDH is one or more of phosphate ester coated MDH and acrylic silane coated MDH.

11. The composition of claim 1 in which the antioxidant is at least one of a hindered phenol, phosphite, phosphonite, thio compound or hindered amine.

12. The composition of claim 1 comprising 20-60 wt % of the Si-g-PE.

13. The composition of claim 1 that is crosslinked.

14. A wire or cable coated with the composition of claim 1.

15. The wire or cable of claim 14 in which the coating is in the form of an insulation sheath or protective jacket.
